(19) United States
(12) Patent Application Publication
(10) Pub. No.: US 2009/0297015 A1
(43) Pub. Date: Dec. 3, 2009

(54) Method for Detecting Contours in Images of Biological Cells

(76) Inventor: Fritz Jetzek, Bremen (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/083,365

(22) PCT Filed: Oct. 12, 2006
(86) PCT No.: PCT/EP2006/067332

§ 371 Date: Aug. 10, 2009

(30) Foreign Application Priority Data
Oct. 13, 2005 (EP) 05109553.7
Dec. 15, 2005 (EP) 05112222.4

(51) Int. Cl. G06K 9/00

(52) U.S. Cl. 382/133

(57) ABSTRACT

A method for identifying membrane contours in images of biological cells is described and comprises the following steps:
detection of a substructure of a biological cell, where the substructure serves to localize the biological cell in the image,
detection of a plurality of landmarks taking account of the spatial position of the substructure,
determination of line segments between pairs of spatially adjacent landmarks,

and combining the line segments to a membrane contour.

In particular, physical/biological information concerning cell membrane stabilization is used as a basis for determining the line segments.

### BACKGROUND

1. Field of the Disclosure

Automatic segmentation of cells in microscope images is one of the most important objects of image analysis in the domain of biology and pharmaceutical research.

2. Discussion of the Background Art

To address biological problems, structures of cells, e.g. receptors or parts of cytoskeletons, are marked with fluorescent dyes. In reaction to external stimuli these structures may react with a re-arrangement. A quantification of such observations requires the segmentation of individual cells within an image. For high-throughput applications, it is of interest to obtain fully automatic methods.

The problem of segmentation is complex since cells have a very heterogeneous morphology that is difficult to model. Further, difficulties are caused by occlusion as well as by cases of neighboring cells grown together, whose interface is hard to associate clearly.

The scientific field of cell recognition in digital images has bred numerous specialised approaches over the decades that each implement a certain paradigm of image processing.

The following is a short summary of the most important fields of research making reference their possibilities and limits.

Thresholding methods are useful especially in the recognition of cell nuclei (Harder, Nathalie; Neumann, Beate; Held, Michael; Liebel, Urban; Erfle, Holger; Ellenberg, Jan; Eils, Roland; Rohr, Karl: Automated Analysis of Mitotic Phenotypes in Fluorescence Microscopy Images of Human Cells, in: Bildverarbeitung für die Medizin 2006, 2006, p. 374-378) (Harder, Nathalie; Neumann, Beate; Held, Michael; Liebel, Urban; Erfle, Holger; Ellenberg, Jan; Eils, Roland; Rohr, Karl; Automated Recognition of Mitotic Patterns in Fluorescence Microscopy Images of Human Cells, in: Proc. IEEE Internat. Symposium on Biomedical Imaging: From Nano to Macro (ISBN2006)}, 2006, p. 1016-1019) (Wirjadi, Oliver; Breuel, Thomas M.; Feiden, Wolfgang; Kim, Yoo-Jim: Automated Feature Selection for the Classification of Meningioma Cell Nuclei, in: Bildverarbeitung für die Medizin 2006, 2006, p. 76-80), since the objects to be recognized are generally spatially separated in the image range and are clearly distinguishable from the background due to their intensity distribution. Moreover, their morphology is compact and often spherical making an intricate formulation of adequate models superfluous.

Voronoi graphs and the related watershed transformation (Roerdink, Jos B. T. M.; Meijster, Arnold: The Watershed Transform: Definitions, Algorithms and Parallelization Strategies, In: Fundamenta Informaticae 41 (2001), p. 187-228) (Cong, Ge; Vaisberg, Eugeni A.: Extracting Shape Information Contained in Cell Images. Pending Patent Application, August 2002.-WO 02/067195 A2) form the classic basis of the presently widespread segmentation methods for cell biology. In those methods, biological background knowledge is included in the detection process insofar as the actual distribution of the dye decreases toward the cell membrane; the assumptions on object borders as ridges in the intensity range, forming the basis of the watersheds, thus become a coarse model of the cell structure.

The algorithms are typically initiated with information about the position of the cell nuclei and then approximate the cell contours, using the local intensity distribution in the cytoplasm (Bengtsson; Wählby, C.; Lindblad, J.: Robust Cell Image Segmentation Methods. In: Patt. Recog. Image Analysis 4 (2004), No. 2, p. 157-167) (Cong, Ge; Vaisberg, Eugeni A.: Extracting Shape Information Contained in Cell Images. Pending Patent Application, August 2002.-WO 02/067195 A2); however, watershed transformation has also yielded results without prior nucleus detection that reach about 90% of the quality of a manual segmentation (Wählby, Carolina; Lindblad, Joakim; Vondrus, Mikael; Bengtsson, Ewert; Björkesten, Lennart: Algorithms for cytoplasm segmentation of fluorescence labelled cells. In: Analytical Cellular Pathology 24 (2002), p. 101-111). Methods have been developed especially for the segmentation of non-dyed cells in bright-field images, which methods use global thresholding methods to first determine the approximate location of the cells and then differentiate the cell forms found based on the intensity variance (Wu, Kenong; Gauthier, David; Levine, Martin D.: Live cell image segmentation. In: IEEE Trans Biomed Eng 42 (1995), p. 1-12).

More recent methods extend the approach of the region-based methods by the use of active contours (snakes) that yield good results even with very noisy material (Rahn, C D.; Stiehl, H. S.: Semiautomatische Segmentierung individueller Zellen in Laser-Scanning-Microscopy Aufnahmen humaner Haut. In: Procs BVM, 2005, p. 153-158). An alternative approach by Ronneberger (Ronneberger, O.; Fehl, J.; Burkhardt, H.: Voxel-Wise Gray Scale Invariants for Simultaneous Segmentation and Classification. In: Procs DAGM, Springer, 2005, p. 85-92) expressly does without a modelling of cells; rather, pixels or voxels are clustered based on the properties of the intensities in the local vicinity. Instead, these methods count on a pixel- or voxel-wise generation of features that yield similar values for points of similar cells. The following clustering of image elements of similar classification then leads to the result set of detected cell objects.

The segmentation of cells can be considered an example of an image processing task where the data are present in such a consistent form that a part thereof can be used to train a classifier. Neural networks present a concept that requires such a data situation and is modelled on human reasoning by training and by automatic learning (backprogagation) (Duda, Richard O.; Hart, Peter E.; Stork, David G.: Pattern Classification. John Wiley & Sons, 2001) (Pal, Nikhil R.; Pal, Sankar K.: A Review on Image Segmentation Techniques. In: Pattern Recognition 26 (1993), No. 9, p. 1277-1794).

Nattkemper (Nattkemper, Tim W.; Wersing, Heiko; Schubert, Walter; Ritter, Helge: A Neural Network Architecture for Automatic Segmentation of Fluorescence Micrographs. In: Procs ESANN, 2000, p. 177-182) proposes an approach for the detection of primarily convex and compact lymphocytes, wherein in a two-phase process first a neural classifier is trained to determine cell coordinates and thereafter the contours are determined on the basis of these coordinates. Here, with a reference to the irregular 2D shape, a morphological modeling of the cell is also omitted.

Applying the genetic paradigm to the problem of cell recognition combines two aspects of modeling. On the one hand, this method of automatic improvement of algorithms or classifiers borrows from the biology of population development (Duda, Richard O.; Hart, Peter E.; Stork, David G.: Pattern Classification. John Wiley & Sons, 2001). On the other hand, measuring the relevance of individual pixels (fitness) requires a model for the characterization of the objects to be found.

For an analysis of rather simple morphologies, a modeling using ellipses has been proposed

$${( \frac{( x - {x}_{0} ) cos θ + ( y - {y}_{0} ) sin θ}{a} )}^{2} + {( \frac{( x - {x}_{0} ) sin θ + ( y - {y}_{0} ) cos θ )}{b} )}^{2} = 1 \qquad ( eq . 1 )$$

(Yang, Faguo; Jiang, Tianzi: Cell Image Segmentation with Kernel-Based Dynamic Clustering and an Ellipsoidal Cell Shape Model. In: Journal of Biomedical Informatics 34 (2001), p. 67-73), whose main axes α and β as well as their orientation θ and centre (x₀, y₀) are related to the also ellipsoidal Gaussian nucleus for the measurement of pixel relations.

This very compact method is suited for a strictly defined set of cell types. In practice (Yang, Faguo; Jiang, Tianzi: Cell Image Segmentation with Kernel-Based Dynamic Clustering and an Ellipsoidal Cell Shape Model In: Journal of Biomedical Informatics 34 (2001), p. 67-73), a high insensitivity to noise was observed. It lends itself better to the detection, rather than to the actual segmentation of cells, since immediately connected objects are not separated.

One of the oldest concepts for object detection is template matching having its basis in the Radon transformation and the Hough transformation derived therefrom. The principle of the general Hough transformation was applied to cell recognition by Garrido and Pérez de la Blanca (Garrido, A.; Bianca, N. P. 1.: Applying deformable templates for cell image segmentation. In: Pattern Recognition 33 (2000), p. 821-832). For a transformation into a Hough space, the authors developed a two-dimensional ellipsoidal contour model. The locations of the cells mapped, obtained through an analysis of the parameter space, were then used to find the actual object contours by an energy optimization of the local intensity distribution.

It is an object of the present disclosure to provide a reliable method for detecting contours in images, especially for detecting cell contours.

### SUMMARY

The disclosure refers to a method for detecting membrane contours in images of biological cells, the method comprising the following steps:
detecting a substructure of a biological cell, said substructure serving to localize the biological cell in the image,
detecting a plurality of landmarks with consideration to the spatial position of the substructure,
determining line segments between pairs of spatially adjacent landmarks, and
combining the line segments to a membrane contour.

Preferably, physical-biological findings regarding the cell statics form the basis of the determination of the line segments.

As a basis for the segmentation of cells in microscopic images, the cells are preferably represented using the physical model of a cytoskeleton. Adherent cells attach to their substrate at discrete points. Within the cell, these points correspond to parts of individual fibers of the cytoskeleton, but especially to terminal points of such fibers. The cytoskeleton is a complex mechanical structure having the nucleus as the reference point. The cell membrane is spanned by the fibers, and the typical shape of cells in preferably confocal 2D images results from the interaction of elastic fibers and their forces, on the one hand, and the cell membrane, on the other hand. According to the present disclosure, the graphs used as models are preferably oriented such that a balance of forces is obtained at each node, and are eventually validated against images of adhesion points in reference cells (e.g. HeLa cells).

In a preferred embodiment of the present method, the prior knowledge about cell growth is used to model the contours of cells. Especially the components of the cytoskeleton, notably the microtubules, intermediary filaments and microfilaments. Findings of the tensegrity model (Ingber, Donald E.: Opposing views on tensegrity as a structural framework for understanding cell mechanics. In: J. Appl. Physiol 89 (2000), p. 1663-1678; Huang, Sui; Ingber, Donald E.: The structural and mechanical complexity of cell-growth control. In: Nature Cell Biology 1 (1999), September, p. E131-E138) are used to define the geometric properties of the contour. According to the hypothesis of tensegrity, the shape of an object results from the skeleton that is stabilized by tensions between its components by reaching a state of equilibrium (Wang, Ning; Tolic-Norrelykke, Iva M.; Chen, Jianxin; Mijailovich, Srboljub M.; Butler, James P.; Fredberg, Jeffrey J.; Stamenovic, Dimitrije: Cell-prestress. L Stiffness and prestress are closely associated in adherent contractile cells. In: Am J Physiol Cell Physiol (2002), p. C606-C616). In particular, use is made of an approach according to which the shape of the cell is the result of two classes of discrete elements: the fibers (struts) that can be compressed in the lengthwise direction, and the tensile elements. The focus of consideration is formed by the axes of growth defined in analogy to the cytoskeleton, the terminal points of the axes are represented on the contour as extreme values of curvature. In particular, the sections between these points can be represented by concave curves of second order. Thus, the approach offers the possibility to detect cell contours in the sub-pixel range.

This methodology is modelled particularly close to biological reality so that it forms the basis for substantially more robust segmentation methods. The problem of segmentation is reduced to the detection of landmarks corresponding to the terminal points of axes of growth. In particular, axes of growth are understood to be local vectors to the membrane contour that characterize the orientation of the contour at this location. Preferably, abstraction from the real fiber is made, since the local orientation of the membrane contour can well be the result of an interaction of a plurality of components of the cytoskeleton, such as fibers.

The main aspect of the method according to the disclosure is the description of cell contours in particular. Physical models, such as Bezier splines, are preferred to explain the continuous concavity of contour sections with respect to the cell nucleus. Here, the axes of growth can be employed directly as a parametrization of the splines.

Moreover, it is preferred to take into account the connection between the local accumulation of axes of growth and the shape of the contour sections between them.

The approach describes was verified using the example of adherent cell tissue. Once the landmarks are available, an acceptable result can be obtained with a model of a section-wise approximation by means of Bezier splines. This is particularly true for far apart landmarks that result in spaciously spanned contour segments.

However, promising results are also obtained in diffuse regions of cytoplasm that, overall, even seem to be convex. In this case, it can be demonstrated that a closer clustering of the axes and an associated flattening of the splines also yield a successful delimitation of the cell over its environment.

On the whole, it becomes evident that the emphasis on biological facts allows for a better detection than would even be conceivable by an observation of the intensity distribution alone.

The approach of the present disclosure is superior to non-modelling methods due to the intensive incorporation of physical-biological findings regarding the cell growth. Despite the hetero-geneous morphology of cells, meaningful general properties exist that ultimately have to be included in a segmentation.

The known properties of the cytoskeleton are also applicable, in a comparable manner, to cells where no distinct axes of growth can be defined. Thus, the approach of the present disclosure can be extended to cells in various environments, e.g. narrow epithelial cell tissues. It is also conceivable to include further constraints such as a relation between the orientation of the cell nucleus and the orientation of the cell as a whole.

The method of the present disclosure is particularly suited for use in the context of automated image processing, preferably by the automatic recognition of landmarks and their association to cells.

### BRIEF DESCRIPTION OF THE DRAWINGS

FIGS. 1 and 2 illustrate the acquisition of landmarks in images of cell tissue. The two left mages each show a cell whose nucleus is close to the centre of the image. Detecting the nucleus is a simple task employing conventional image analysis methods. Extreme values of curvature on the cell membrane are identified as landmarks. The axes of growth (see the respective picture on the right) are then defined as connections of such a mark with the closest point on the contour of the cell nucleus.

FIGS. 3 and 4 again show the contour of the nucleus and axes of growth (see the respective picture on the right), as well as Bezier splines, whose position is defined immediately by the axes.

FIG. 5 is an image of cancerous bone marrow tissue (U2OS cells) where the cytoplasm has been highlighted by corresponding dying (see embodiment 3).

In FIG. 6, the cell nucleus line and axes of growth are drawn in the same image.

FIG. 7, in turn, shows the result of a membrane approximation with splines, the approximated membrane contour having been formed using directional vectors of different scale.

FIGS. 8 and 9 show two other results obtained this way.

FIG. 10 illustrates the principle of contour modelling (for further explanations also refer to embodiment 1).

FIG. 11 illustrates a membrane approximation using splines (for further explanations also refer to embodiment 1).

FIG. 12 illustrates the hierarchic clustering of landmarks (for further explanations also refer to embodiment 2).

FIG. 13 is an exemplary illustration of an adjacency matrix of a tree seen in depth-first order (for further explanations also refer to embodiment 2).

FIG. 14 shows images of HeLa cells in three different spectral channels with the nuclei, the cytoplasm and the adhesion points being dyed (for further explanations also refer to embodiment 2).

FIG. 15 illustrates the result of the localization and segmentation. The images concern cells in three different spectral channels with the cell nuclei, the cytoplasm and the adhesion points being dyed.

FIG. 16 illustrates examples of cytoskeleton graphs (for further explanations also refer to embodiment 2).

FIG. 17 illustrates a flowchart of the present method in a preferred embodiment.

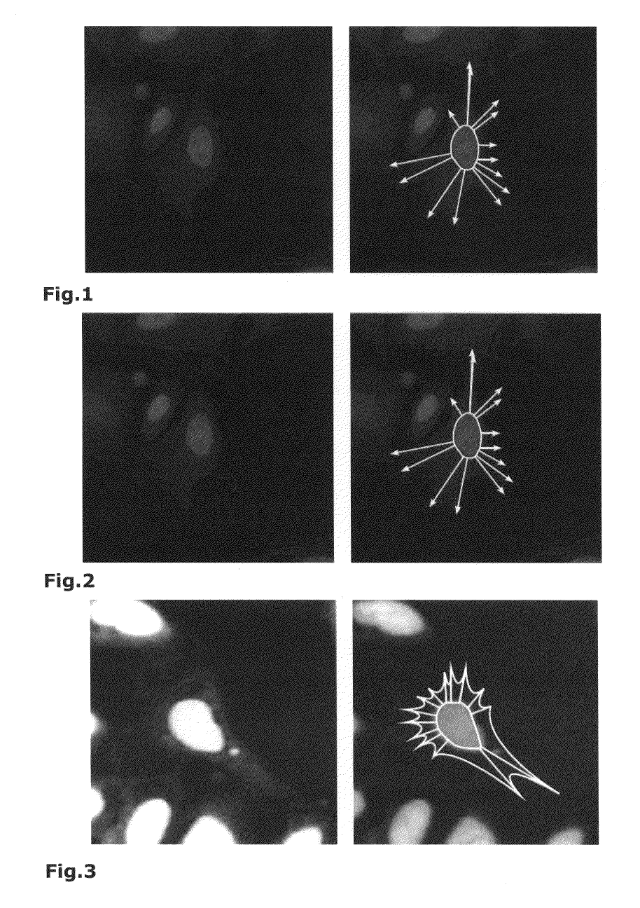

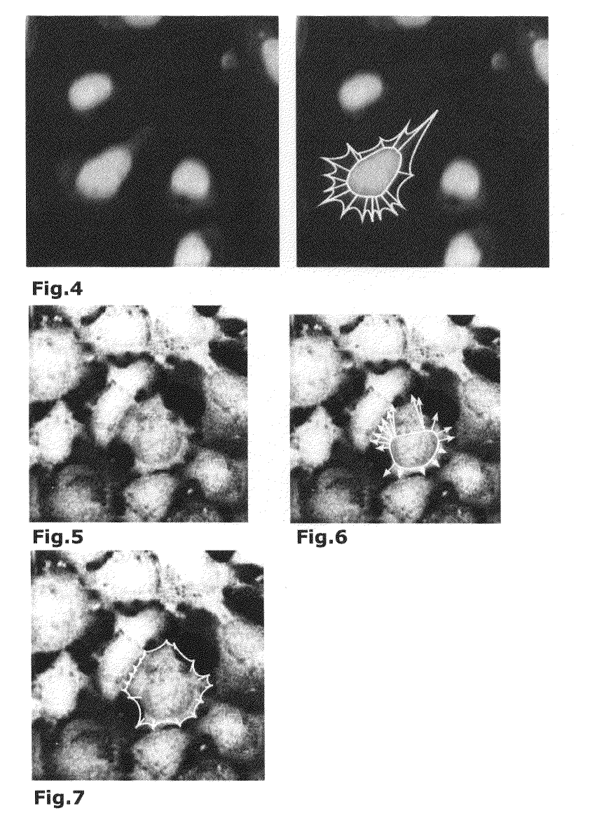

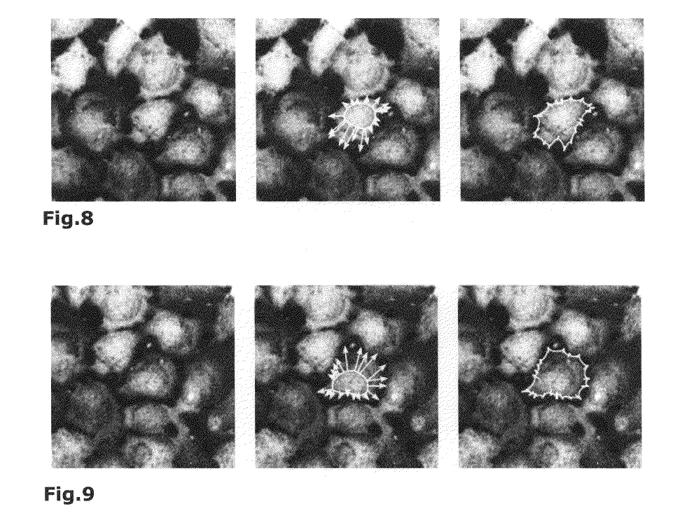

### DETAILED DESCRIPTION OF THE PREFERRED EMBODIMENT

Hereinafter, the disclosure is detailed with reference to embodiments thereof.

### Embodiment 1

The model of an adherent cell presented herein puts emphasis on the calculation of the membrane, which, die to the data being present in the second dimension, means a line. At the same time, a simple inner structure for the construction of a cell is proposed.

Morphology of the Cell

The shape of a cell substantially results from the cytoskeleton, a combination of fibers internal to the cell, on the one hand, and the membrane, which is a bordering surface enclosing the cell, on the other hand. The skeleton is made from a framework of fibers connected at discrete points. Terminal points of the fibers penetrate the membrane and, by means of receptors, form a connection to the surrounding tissue or to the substrate. As used in the present embodiment, the terms inner and outer adhesion points refer to the adhesion points among the fibers or to the connection points of the fibers and materials surrounding the cell. Fibers having an outer adhesion point may often be considered axes of growth since they roughly coincide with the direction of cell growth or also with their movement in this direction. Actually adhesions are areas which, however, due to their small size of about 1μ compared to the cell volume, are referred to as points (Sackmann, Erich: Haftung für Zellen. In: Physik Journal 5 (2006), No. 8/9, p. 27-34). A further relevant finding is that the adhesion of the cell to its environment is established exclusively through these adhesion points; both the cell-cell adhesion and the adhesion of a cell to a substrate are a plurality of discrete adhesion points and no continuous connection exists.

Salient Pixels as a Basis of Membrane Description

Modelling the shape of a cell is based on findings regarding the cell growth and the internal cell structure. The tensegrity model expressly allocates different mechanical functions for the inner stability of the cell to the components of the cytoskeleton: the fibers are classified as microtubules, intermediary fibers and microfilaments (Alberts, Bruce; Bray, Dennis; Lewis, Julian; Raff, Martin; Roberts, Keith; Watson, James D.: Molecular Biology of the Cell. Garland Publishing, 1983). The central aspect of the consideration is on the axes of growth of the cell defined on the basis of the cytoskeleton, the terminal points of the axes existing as extreme values of curvature on the contour. The sections between these points may be represented as curves of the second order. The approach thus offers the possibility to detect cell contours in the sub-pixel range. This methodology is closely related to biological findings, so that a basis for robust segmentation methods is formed herewith. The problem of segmentation is reduced to the detection of landmarks (also referred to as “salient points”) corresponding to the terminal points of axes of growth.

Physical Modelling of Cells

The membrane of a cell is composed of a network of spectrine fibers arranged in a hexagonal lattice (Liu, Shih-Chun; Derick, Lauro H.; Palek, Jiri: Visualization of the Hexagonal Lattice in the Erythrocyte Membrane Skeleton. In: The Journal of Cell Biology (1987), March, p. 527-536). In the nanometer range, discrete paradigms are useful for a formal description. However, the present images, due to their much lower resolution (micrometer scale instead of nanometer scale), only allow a less distinctive view, so that in the following only continuous calculations are made for the membrane itself. These are based on the insight that the membrane dynamically adapts to the shape of the cell; this phenomenon is comparable to the behavior of a film which is adapted to an irregularly shaped object while air is being withdrawn (shrink-wrap) (Heidemann, Steven R.; Wirtz, Denis: Towards a regional approach to cell mechanics. In: TRENDS in Cell Biology (2004), April, No. 4, p. 160-166). In keeping with this observation, Helfrich (Helfrich, W.: Elastic properties of lipid bilayers. Theory and possible experiments. In: Z. Naturforschung C 28 (1973), p. 11-12) has proposed the following energy-functional as a model of a cell membrane:

$$J = \frac{1}{2} k \int {( {c}_{1} + {c}_{2} - {c}_{0} )}^{2} d A + {λ}_{1} \int d V + {λ}_{2} \int d A \qquad ( eq . 2 )$$

Here, the first integral describes the membrane curvature, κ is a modulus of elasticity, C₁ and C₂ are the main curvatures, and C₀ is the spontaneous curvature of the membrane. λ₁ and λ₂ are Lagrange multipliers for yielding the cell volume and surface area, and can be interpreted as surface tension, phenomena of the amphipathic structure of the membrane or as osmotic pressure.

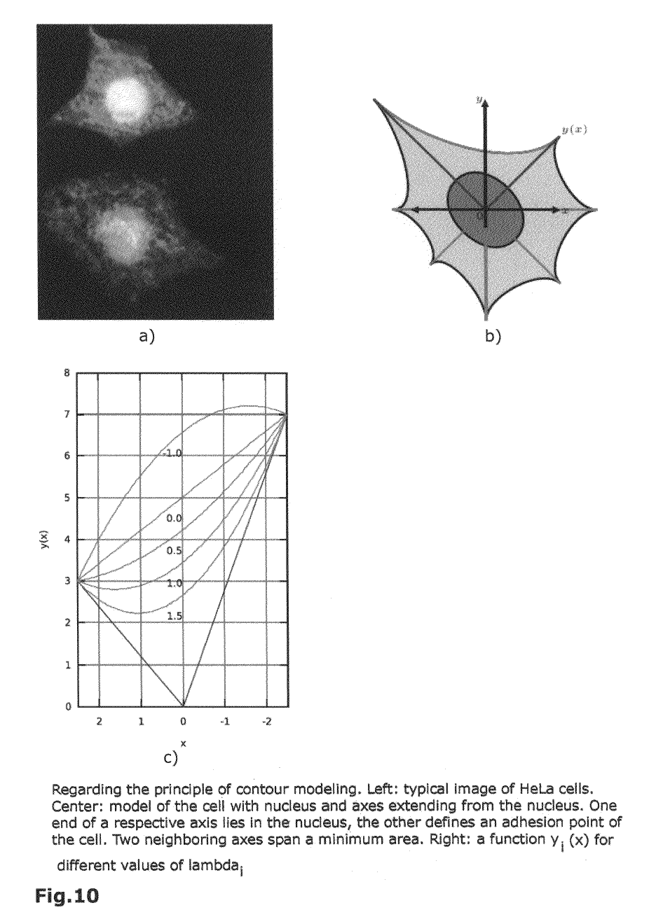

For an efficient segmentation of image data, however, it is preferred to take into account the quite complex structure of many cell types. According to the present disclosure, a 2D segmentation of adherent star-shaped cells uses a functional as a cell model, which is based on eq. 2, the functional minimizing the projection surface of the cell (the volume in 3D) as well as the square of the contour length (the square of the surface in 3D) under given marginal conditions. The use of the square of the contour length allows to describe an elastic cell membrane. The cell is partitioned into N triangular segments Sᵢ, a respective corner of which lies in the centre of the nucleus. The other two corners lie on the cell contour on terminal points (landmarks) pᵢ of adjacent cell axes (cf. the cytoskeleton). The contour part (which is mostly convex for the cells observed) in Sᵢ between the landmarks pᵢ and pᵢ₊₁ is designated yᵢ(x) in a local coordinate system (see FIG. 10). For each segment Sᵢ, the functional will read as follows:

$${I}_{i} [ y ] = {\int }_{{x}_{0}}^{{x}_{1}} 1 + {( {y}_{i}^{t} )}^{2} d x + {λ}_{i} {\int }_{{x}_{0}}^{{x}_{1}} {y}_{i} d x \qquad ( eq . 3 )$$

The first integral minimizes the square of the contour length, and the second term minimizes the surface area. The λ₁ control the relative significance of the respective surface area.

The integral in eq. 3, as

$${I}_{i} [ y ] = {\int }_{{x}_{0}}^{{x}_{1}} {λ}_{i} {y}_{i} + 1 + {( {y}_{i}^{t} )}^{2} d x , \qquad ( eq . 4 )$$

follows the scheme of

$$I [ y ] = {\int }_{a}^{b} f ( t , y ( t ) , {y}^{′} ( t ) ) d t \qquad ( eq . 5 )$$

and may be developed by

$${f}_{y} ( t , {y}_{0} , {y}_{0}^{′} ) - \frac{d}{d t} {f}_{{y}^{′}} ( t , {y}_{0} , {y}_{0}^{′} ) = 0 \qquad ( eq . 6 )$$

into the Euler-Lagrange equation

λᵢ−2y″ᵢ=0 (eq. 7)

(Ansorge, Rainer; Oberle, Hans J.: Mathematik für Ingenieure, Band 2. Akademie, 1994). Thus, a square function parametrized with λ₁ is obtained for yᵢ(x):

$${λ}_{i} - 2 {y}_{i}^{″} = 0 \\ ⇔ \int {y}_{i}^{″} ( x ) d x = \int \frac{1}{2} λ d x \\ ⇔ {y}^{′} ( x ) = \frac{1}{2} λ x + {c}_{1} \\ ⇔ \int {y}^{′} ( x ) d x = \int \frac{1}{2} λ x + {c}_{1} d x \\ ⇔ y ( x ) = \frac{1}{4} λ {x}^{2} + {c}_{1} + {c}_{2} \qquad ( eq . 8 )$$

With the use of two coordinates (x₁/y₁) and (x₂/y₂) as marginal conditions, the constants c₁ and c₂ can be calculated, so that for y(0)=7 and y(5)=3 is obtained, for example.

$${c}_{1} = - \frac{4}{5} - \frac{5}{4} λ \\ {c}_{2} = 7 \\ ⇔ y ( x ) = \frac{1}{20} ( 5 λ {x}^{2} - 16 x - 25 λ x + 140 ) . \qquad ( eq . 9 )$$

An example for y(x) with a varying λ is given in FIG. 10c.

Thus, according to this model, the contour of a cell can be described piece by piece by polynomials of a low order.

To be able to state the marginal conditions for each contour piece yᵢ symmetrically, cubic spline curves are used. The parameters of curvature λ_{I} are determined by the cell type and the respective axes of growth.

Implementation

An implementation of the model for the analysis of images of cells from cancerous human bone marrow tissue (U-2OS) starts from given landmarks pᵢ. They mark extreme values of curvature of the membrane line. From their position relative to each other and to the nucleus, the membrane line is determined from sections yᵢ(x) of different length and following a more or less strongly curved path.

The cell nucleus has been detected in advance. In the concrete instance of fluorescence microscopy, multi-channel images with specially dyed nuclei can be generated, for example, from which the individual nuclei can be extracted by simple threshold analysis and connected component labelling (Davies, E. R.: Machine Vision. Academic Press, 1997).

For each landmark pᵢ, the closest landmark p′_{I} on the nucleus membrane is calculated. Both points together for a local direction vector Pᵢ=pᵢ−p′_{I} (the axis of growth) roughly indicating the orientation of the cytoplasm in this direction. The plurality of these vectors can be sorted in the order of their root points p′_{I} on the nucleus line; partial problems occurring in the process, such as the sorting of vectors with identical root points, are solved with an analysis of the local position of the vectors relative to the contour of the nucleus. This sorting method is unambiguous for compact star-shaped cells.

The axes of growth are used to parametrize the contour sections yᵢ(x) respectively spanned between adjacent vectors.

The considerations regarding the minimization of surface area and arc length can be implemented with the use of the length and the span of respective adjacent axes. To obtain a measure of the latter, first, all axes are standardized to

$${n}_{i} = \frac{{P}_{i}}{‖ {P}_{i} ‖} \qquad ( eq . 10 )$$

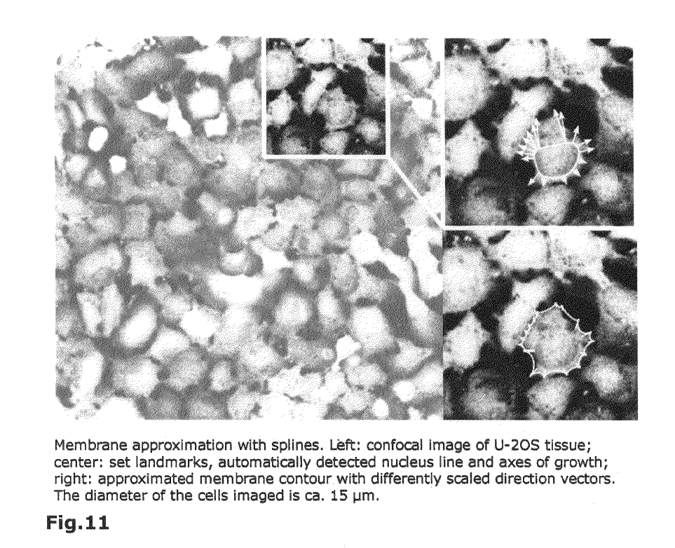

and then the scalar product +nᵢ, nᵢ₊₁, is calculated for the respective adjacent axes. The range of values thereof is given by [−1, 0.1] for the present contours, where −1 stands for the maximum angle of 180°. The range is mapped to [1 . . . 0] to obtain higher values for larger spans. Finally, nᵢ and nᵢ₊₁ are scaled by the respective values formed. For the modelling of membrane line sections yᵢ(x) by means of a cubic spline, the pairs thus formed are then used immediately for parametrization (see FIG. 11).

The method described accounts for the shape of adherent cells as the result of a membrane spanned between adjacent points. Once the landmarks are available as estimates of those points, an acceptable approximation can be achieved with the model of a segment-wise approximation of the cell contour using Bezier splines. This is particularly true for far apart landmarks resulting in spaciously spanned contour segments.

However, good results are also obtained in diffuse portions of the cytoplasm which, all in all, rather seem convex. A tighter bundling of the axes and an associated flattening of the splines advantageously causes a successful delimitation of the cell against its environment.

In practice, the use of cubic Bezier splines

C(t)=Σᵢ₌₀³P_{i,}β_{i,3}

with the Bernstein polynomials

$${B}_{i , 3} = ( \begin{matrix}3 \\ i\end{matrix} ) {{t}^{i} ( 1 - t )}^{3 - i} , 0 \leq t \leq 1$$

is particularly well suited. This method allows to suitably define a curve

C(t)=P₀(1−t)³+3P₁t(1−t)²+3P₂t²(1−t)+P₃t³, t∈0, 1]

extending through the points P1 and P3, and whose position is indicated by the vectors P0-P1 and P3-P2, respectively, without the curve passing through these two points P0 and P2. Here, a great distance **Pj-Pk** results in a deep pocket in the curve along this vector. The application of this method is advantageous since the curve defined by the four points always extends within the convex shell of the corresponding polygon. According to the physical-biological model presented here, the vectors flanking the curve stand for adjacent fibers or axes in the cytoskeleton model; they can not be exceeded laterally by the membrane.

### Embodiment 2

In less dense monolayers cells grow with a relatively high degree of freedom so that the cytoplasm with the surrounding membrane takes an irregular shape. The nucleus of a cell is then often offset from the centre and the tensions between outer adhesion points and the inside of the cell can no longer be described as a circular nucleus-related bundle of vectors.

A model that would be realistic in this sense should thus also include inner adhesion points besides the outer adhesion points.

Within a cell, the adhesion points are interconnected by actine fibers (Wang, Ning; Naruse, Keiji; Stamenovic, Dimitrije; Fredberg, Jeffrey J.; Mijailovich, Srboljub M.; Tolic-Norrelykke, Iva M.; Polte, Thomas; Mannix, Robert; Ingber, Donald E.: Mechanical behaviour in living cells consistent with the tensegrity model. In: Proc Natl Acad Sci USA (2001), July, No. 14, p. 7765-7770); they form the terminal points of those fibers. The connections are subject to mechanical forces (Wang, Ning; Tolic-Norrelykke, Iva M.; Chen, Jianxin; Mijailovich, Srboljub M.; Butler, James P.; Fredberg, Jeffrey J.; Stamenovic, Dimitrije: Cell prestress. I. Stiffness and prestress are closely associated in adherent contractile cells. In: Am J Physiol Cell Physiol (2002), S. C606-C616) (Wang, Ning; Naruse, Keiji; Stamenovic, Dimitrije; Fredberg, Jeffrey J.; Mijailovich, Srboljub M.; Tolic-Norrelykke, Iva M.; Polte, Thomas; Mannix, Robert; Ingber, Donald E.: Mechanical behaviour in living cells consistent with the tensegrity model. In: Proc Natl Acad Sci USA (2001), July, No. 14, p. 7765-7770) (Wendling, S.; Planuns, E.; Laurent, V. M.; Barbe, L.; Mary, A.; Oddou, C; Isabey, D.: Role of cellular tone and microenvironmental conditions on cytoskeleton stiffness assessed by tensegrity model. In: Eur. Phys. J. 9 (2000), p. 51-62); this is referred to as the inner tension of a cell or the tone (Wendling, S.; Planuns, E.; Laurent, V. M.; Barbe, L; Mary, A.; Oddou, C; Isabey, D.: Role of cellular tone and microenvironmental conditions on cytoskeleton stiffness assessed by tensegrity model. In: Eur. Phys. J. 9 (2000), p. 51-62) (Kuchling, Horst: Taschenbuch der Physik Harri Deutsch, 1985):

$${\sum }_{i} {F}_{i} = 0 \qquad ( eq . 11 )$$

For the calculation of the point of attack with given global coordinates of the force vectors and non-existent resulting forces, eq. 11 is subjected to a translation (Fellner, Wolf-Dietrich: Computer-grafik BI-Wissenschaftsverlag, 1992):

$${\sum }_{i = 1}^{n} {F}_{i} = 0 \\ ⇔ {\sum }_{i = 1}^{n} {F}_{i} + t = t \\ ⇔ {\sum }_{i = 1}^{n} {F}_{i} + \frac{n}{n} t = t \\ ⇔ \frac{1}{n} {\sum }_{i = 1}^{n} ( {F}_{i} + t ) = t \qquad ( eq . 12 )$$

The point of attack at an equilibrium of forces thus exactly corresponds to the geometric centre of gravity of the forces acting.

The following hypothesis is worded: the balance of forces should be even at each adhesion point when the skeleton is at rest.

The following presents a model that includes both outer and inner adhesion points and indicates a structure for the organization thereof in a skeleton. The basis of the model is formed by a graph in the form of a tree (n-ary), the leaf nodes of which correspond to outer adhesion points, while the inner nodes correspond to inner adhesion points (see below). Thereafter, a method is presented by which such a tree can be orientated such that the balance of forces of the foregoing equation is fulfilled in each point.

Clustering

In order to construct a tree as a model of the cytoskeleton, already known outer adhesion points and the cell nucleus are used as a first basis. It is assumed that adhesion points can not readily be related directly with the nucleus area, such as when they form a cluster whose elements are close to each other but far from the nucleus. As before, the vectors are eventually intended for the parametrization of membrane splines, Preferably, a non-observed hierarchic clustering is used (Duda, Richard O.; Hart, Peter E.; Stork, David G.: Pattern Classification. John Wiley & Sons, 2001). This is a divisive (or top-down) method, where an initially known set of samples is divided into complementary sets. The strategy of calculating inner adhesion points from the position of the outer ones correlates with the finding that the former have a much weaker bond to the substrate and also become displaced more easily by skeletal tensions (Wehrle-Haller, Bernhard; Imhof, Beat A.: The inner lives of focal adhesions. In: TRENDS in Cell Biology (2002), August, No. 8, p. 382-389).

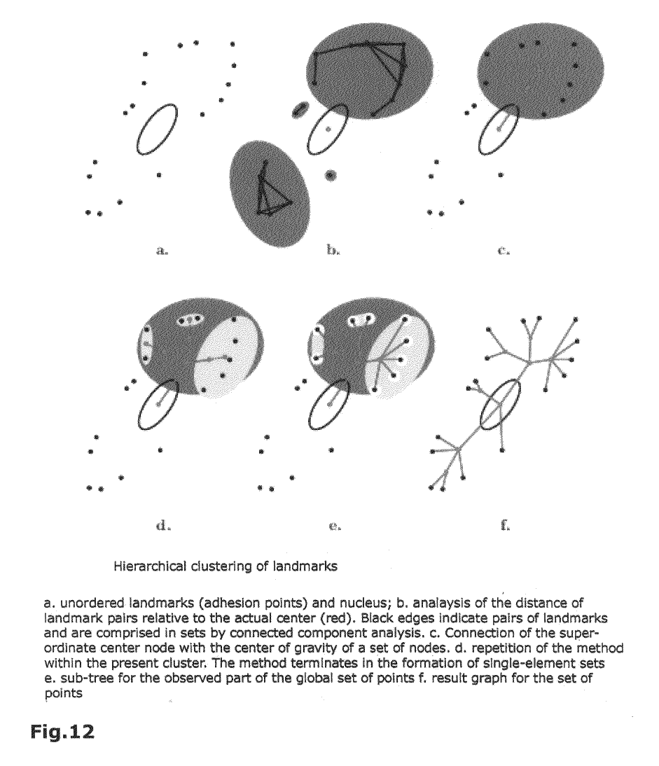

A point set of landmarks shall be given, which symbolize the outer adhesion points of an adherent cell (FIG. 12a). The core shall also be known, and its centre C shall be part of the set.

In a first step, the distance matrix D is established. If it is true for two optional landmarks A and B that

$${D}_{AB} \leq \frac{1}{n} ( {D}_{AC} + {D}_{BC} ) ; \qquad ( eq . 13 )$$

an edge (A, B) is defined. The comparison is carried out for all combinations of landmarks.

A connected component clustering (Aho, Alfred V.; Ullman, Jeffrey D.: Foundations of Computer Science. W. H. Freeman and Company, 1995) is performed on the resulting set of edges so as to combine all points into partial sets. These are illustrated in FIG. 12b.

A new reference point is then defined for an individual cluster. The center of gravity of the cluster C′ is calculated and shifted towards the superordinate reference point C. As a heuristic approach to the shifting, a scaling of the distance of both points is chosen as a function of the current depth d′ of the tree:

$$\frac{1}{\sqrt{{d}^{′}}} \overline{{CC}^{′}} , {d}^{′} > 1 \qquad ( eq . 14 )$$

Equation 13 is then again applied to the elements of the present cluster and the edges thus defined are subjected to a connected component clustering. FIG. 12d illustrates the newly formed partial sets. Again, centers of gravity are calculated and shifted towards the superordinate reference point using equation 14 (d′=3).

The next repetition of the clustering leads to the formation of Singleton clusters (FIG. 12a); their respective element is then connected directly with the reference point. The same procedure is used if clustering yield only a single new cluster that corresponds to the previous one.

In this method, the parameter n in equation 13 has a substantial influence on the shape of the tree and can be used to adapt the shape of the graph to different cell types. For n 0*0 . . . 1*, all elements are combined into a single cluster already in the first iteration; a graph is obtained, whose set of edges directly connects the root node with all points.

With n=1, the equation 13 corresponds to the triangle inequality (Bronstein, I. N.; Semendjajew, K. A.; Musiol, G.; Mühlig., H.: Taschenbuch der Mathematik, Harri Deutsch, 2005)

||χ+γ||≦||χ||+||γ|| eq. 15).

It is only with values n>1 that real partial sets of a cluster are formed.

FIG. 12f shows the entire dendrogram (Duda, Richard O.; Hart, Peter E.; Stork, David G.: Pattern Classification. John Wiley & Sons, 2001) of this classification method as an illustration of the nested clusters.

Equalization of the Balances of Forces

At each connection node of inner cell fibers, an equilibrium of the attacking forces exists, such as in eq. 11 (Wang, Ning; Tolic-Norrelykke, Iva M.; Chen, Jianxin; Mijailovich, Srboljub M.; Butler, James P.; Fredberg, Jeffrey J.; Stamenovic, Dimitrije: Cell prestress. I. Stiffness and prestress are closely associated in adherent contractile cells. In: Am J Physiol Cell Physiol (2002), p. C606-C616). In order to include this property in the model, the coordinates of the internal nodes are calculated anew after the clustering. This can be done using a linear equation system formulated on the basis of adjacency matrices (Bronstein, I. N.; Semendjajew, K. A.; Musiol, G.; Mühlig, H.: Taschenbuch der Mathematik Harri Deutsch, 2005).

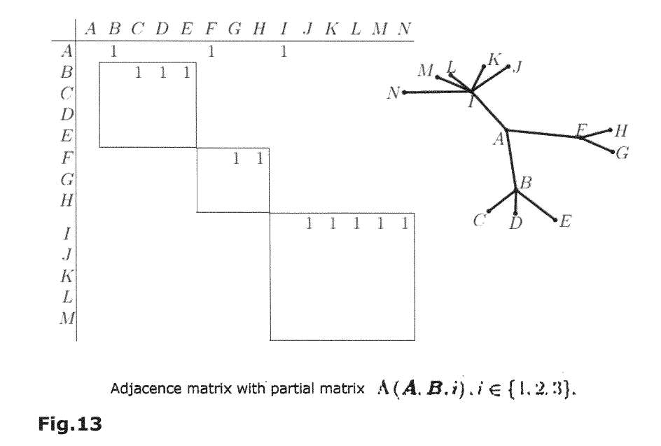

Prior to the encoding of the orientated tree, the nodes thereof are first sorted in a depth-first order (Pavlidis, T.: Structural Pattern Recognition. Springer, 1977), whereby a triangular matrix is obtained, the structure of which represents the division of the tree in partial trees. An example of such a is found in FIG. 13. The areas of the matrix marked with a rectangle in the Figure will be referred to as partial matrices in the following text and correspond to the partial trees.

What is searched for is the solution vector l=ƒ(A, l₀, x₀) of the adjacency matrix A, whose elements include the coordinates of all tree nodes in the above mentioned order. The vector of all nodes, i.e. of already known coordinates of the leaf nodes and the unknown inner nodes, serves as the initial vector l₀. x₀ is similar to the root node of the transferred matrix; for the initial call xₓ=0, since in this case, no node superordinate to the matrix exists. ƒ( ) is defined recursively with a case differentiation:

$$f ( A , l , x ) = \{ \begin{matrix}l , & if n = 1 \\ ( \begin{matrix}\frac{1}{{b}_{11} + 1} ( 〈 ( \begin{matrix}{a}_{11} \\ ⋮ \\ {a}_{1 n}\end{matrix} ) , l 〉 + x ) \\ g ( 1 , A , B , l , x )\end{matrix} ) & otherwise\end{matrix} \qquad ( eq . 16 )$$

In the case of n=1, l will include only a single two-dimensional node co-ordinate. If not, a vector is calculated whose first component indicates the point of attack of the force vectors (cf. eq. 12); for x=0, however, it is calculated instead:

$$\frac{1}{{b}_{11}} 〈 ( \begin{matrix}{a}_{11} \\ ⋮ \\ {a}_{1 n}\end{matrix} ) , l 〉 \qquad ( eq . 17 )$$

since in this case no superordinate root node x exists. Due to the structure of the matrix indicated in FIG. 13, the scalar product of the first line vector (a₁₁ . . . a₁ₙ)^{T} of A with the vector l involves exactly those nodes of the graph that are connected with the currently calculated point by a [symbol] stein, I. N.; Semendjajew, K-A.; Musiol, G.; Mühlig, H.: Taschenbuch der Mathematik Harri Deutsch, 2005) includes their number.

The remaining components of the resulting vector of eq. 16 are defined by a second function g( ) for dividing the matrix A:

$$g ( i , A , B , l , x ) = \{ \begin{matrix}( \begin{matrix}{l}_{{T}_{i}} \\ ⋮ \\ {l}_{n}\end{matrix} ) & if i > {b}_{11} \\ ( \begin{matrix}f ( Λ ( A , B , i ) , λ ( l , i ) , {l}_{1} ) \\ g ( i + 1 , A , B , l , x )\end{matrix} ) , & otherwise\end{matrix}$$

The functions

$$\begin{matrix}Λ ( A , B , i ) = ( \begin{matrix}{a}_{{τ}_{i} {τ}_{i}} & … & {a}_{{τ}_{i} {T}_{i}} \\ ⋮ & & ⋮ \\ {a}_{{T}_{i} {τ}_{i}} & … & {a}_{{T}_{i} {T}_{i}}\end{matrix} ) \\ and & ( eq . 19 ) \\ λ ( l , B , i ) = {( {l}_{{T}_{i}} … {l}_{{T}_{i}} )}^{T} & ( eq . 20 )\end{matrix}$$

extract the i-th partial matrix of A and the corresponding partial vector of l with the help of

Tᵢ:=tΥᵢ₋₁(B) (eq. 21)

and

[symbol]

For T, the traces of the partial matrices of the valence matrix are thus summed up to the i-th partial matrix. Applied to the valence matrix B, the vertical coordinates of the partial matrix searched in A are thus obtained. The following functions are used herein:

$${tr}_{i} ( B ) = \{ \begin{matrix}2 , & if i = 0 \\ \text{?} \text{?} \text{?} & otherwise\end{matrix} \\ \text{?} \text{indicates text missing or illegible when filed}$$

to calculate a matrix index from the ordinate number of a partial matrix, i.e. the indication at which position the i-th direct partial tree of the currently observed root is situated in A,

$$str ( B , i ) = \{ \begin{matrix}0 , & if {b}_{ii} = 0 \\ ltr ( B , {b}_{ii} , i ) + {b}_{ii} , & otherwise\end{matrix} \qquad ( eq . 24 )$$

situated at a₁ᵢ, where the valence matrix B is expected for str( ), as well as

$$\begin{matrix}ltr ( B , b , i ) = \{ \begin{matrix}str ( B , i + 1 ) , & if b = 1 \\ β + str ( B , β + b + i ) , & otherwise\end{matrix} \\ with & ( eq . 25 ) \\ β = ltr ( B , b - 1 , i ) & ( eq . 26 )\end{matrix}$$

for the sum of the traces of all partial matrices directly related to the same root.

In this manner, a vector l=ƒ(A, l₀, x₀) is obtained, by whose com- [symbol] method is proposed to solve the same, which follows the same recursive scheme of equations 16 and 18.

Experimental Implementation

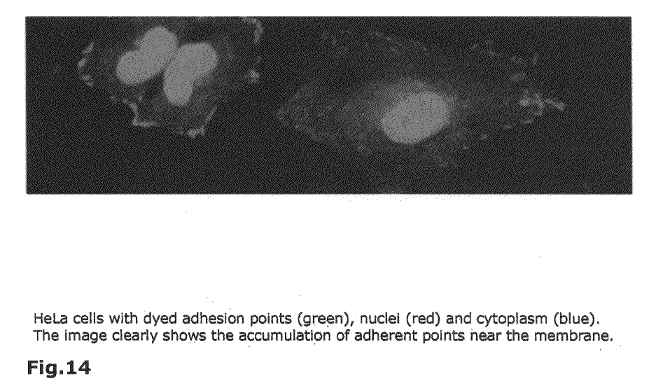

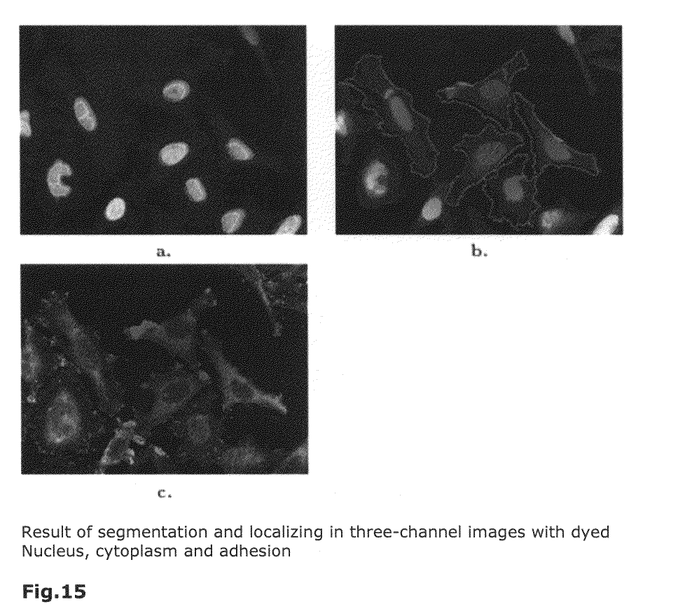

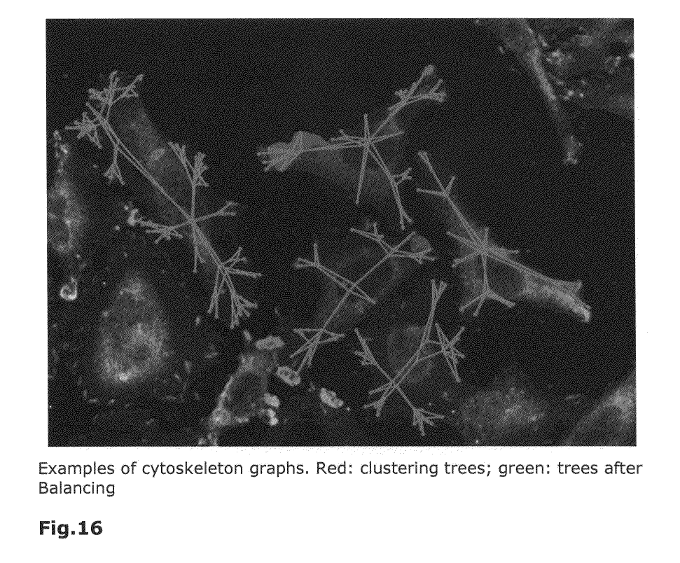

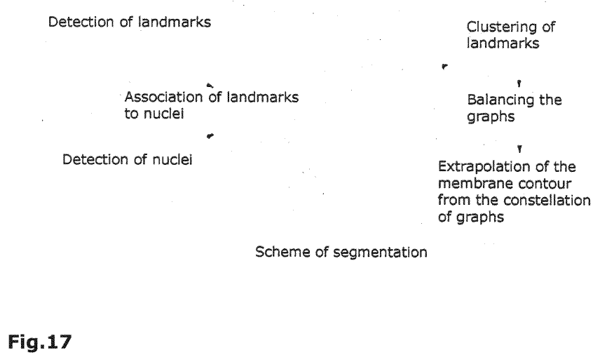

The above described model will be implemented in an exemplary manner [symbol] t spectral channels are used, the nuclei, the cytoplasm and the adhesion points being dyed (FIG. 14); such dying methods have been described extensively in the pertaining literature.

On the corresponding channels, first, a detection of the nuclei and, [symbol] r, the adhesion points are localized and classified as inner and outer points according to their position relative to the cytoplasm segmentation. For the set of cells detected in the segmentation step, the respective outer adhesion points are used in building the above presented model. Here, [symbol] tual positions of the inner adhesion points, as they have been determined by an analysis of the images. Thus, the verification of the model is a comparison of the prediction made on these points with the real locations.

[symbol] lution of 1345×991 in PNG format.

Only those connections are dyed as inner adhesion points that exist between terminal fiber points and the outside of the cell, not those connections between fibers in the cell.

The object detection described hereinafter has been performed with the [symbol] ciency, the images are first scaled to a quarter of the original resolution; in doing so, the median of the respective intensities of four respectively adjacent pixels is selected. Then, a simple global thresholding analysis is performed on the image of the cell nuclei; the binary map or mask [symbol] t labeling giving consideration to 8-neighborhoods, the objects of the stencil already largely corresponding to the nuclei to be detected. In order to prevent a plurality of closely adjacent cell nuclei from being detected as one nucleus, heuristics for the separation of objects is incor-

[symbol]

The objects known to that moment are divided into inner equidistant zones with an interval of

(N·Δd, N·Δd+Δd), N={0, 1, . . . } (eq. 27)

so that Δd corresponds to the zone width (Kirsch, Achim; Ollikainen, [symbol] s of Particle Images}. WO 03/088123 AI). The intensity values of the image function g(x) are multiplied by a zone function h(x) that yields the value N of the zone that contains x. In this manner, maximum intensity values are produced that almost correspond to the actual centers of the nuclei. The [symbol] ization points of a watershed transformation in the area of the previously established binary map (Roerdink, Jos B. T. M.; Meijster, Arnold: The Watershed Transform: Definitions, Algorithms and Parallelization Strategies. In: Fundamenta Informaticae 41 (2001), p. 187-228). The objects formed with this transformation largely correspond to the nuclei to be detected and also address mutually tangent [symbol] by a filtering of the objects in dependence on their size. At the given resolution, a satisfactory result was obtained with a minimum size of 100 pixels.

To detect the cytoplasm in the second spectral channel, first an [symbol] g locally overexposed areas. These may occur as contaminations in a cell culture and interfere with the segmentation process. To do so, the method described for the detection of nuclei is repeated for the cytoplasm image, and the result is compared to the nuclei [symbol] o overlap with the nuclei. Another thresholding analysis again yields a binary map from which the artifact areas are subtracted. The result is used as a spatial delimitation for a subsequent application of the watershed transformation. The latter is initiated with [symbol] d whose number corresponds to the number of the nuclei and which each correspond to a nucleus.

Because of the very heterogeneous intensity distribution of the cytoplasm, a simple application of the transformation is insuffi- [symbol] , a simple smoothing is performed by

$$\frac{1}{9} ( \begin{matrix}1 & 1 & 1 \\ 1 & 1 & 1 \\ 1 & 1 & 1\end{matrix} ) \qquad ( eq . 28 )$$

and another transformation is performed. Here, for each pixel considered for regional growth, other than in the classic watershed transformation, not only the intensity of the individual [symbol] all adjacent pixels. By proceeding in such a manner, a substantially more comprehensive coverage of the cytoplasm area provided as a border is achieved.

It is advantageous for the intended verification to only consider [symbol] e should be removed that project beyond the edge of the image. Strictly deleting all objects that have at least one point in common with the outermost image coordinates would be too rigid a proceeding which would not consider many cells that are quite [symbol] n only objects with more than 20 of such points are removed. The cytoplasm detection with the automatic filling of all holes occurring within objects. Moreover, objects are deleted that have an area smaller than 500 pixels, thus being too small to correspond

[symbol]

The localization of the adhesion points was performed on the third spectral channel in the form of a search for maxima. The area to be analyzed is similar to the image area defined by the cytoplasm detection. Here, points are considered to be maxima if they have a maximum brightness within a radius of three pixels. Further, the contrast between the maximum I_{Peak} and lowest intensity I_{Reference}

$$\frac{{I}_{Peak} - {I}_{Reference}}{{I}_{Peak} + {I}_{Reference}} \qquad ( eq . 29 )$$

of the respective area observed should be at least 0.2 on this im-

[symbol]

$$\frac{{I}_{Peak}}{{I}_{Cell}} \qquad ( eq . 30 )$$

was determined as being a value of 1, 1; this last parameter uses I_{cell} as the mean intensity of the respective cell area. From the salient areas (spots) thus calculated, the respective maximum is

[symbol]

The above described segmentation is carried out. Using the clustering method detailed above, graphs for the models of the cytoskeletons are constructed from the extracted adhesion points, and the graphs are balanced. A few examples of these graphs are [symbol] s salient points or leaf nodes) thus determined and the vectors connecting these with their associated parent node, splines are preferably used—as already described in embodiment 1—to reconstruct the contour of the cell membrane section for section.

As an example, the method forming the basis of the present disclosure was used in the analysis of cancerous bone marrow tissue (U2OS cells). For an implementation of the inventive idea in the examination of cells in cancerous human bone marrow tissue (U2OS), the existence of landmarks is presumed initially. They shall designate those points on the cell membrane line that repre- [symbol] tion, according to which the membrane line is composed of sections that differ in length and are more or less explicitly concave. Thus, the concavity directly depends on the local density of landmarks. Therefore, in the cells analyzed in the present example [symbol] t was performed on dyed nuclei, from the result of which the nuclei can be extracted by a simple thresholding analysis and connected component labeling (T. Pavlidis: Structural Pattern Recognition. Springer 1977). Thus, a nucleus border line was detected which indicates [symbol] sentation.

For each landmark the closest point on the nucleus line was determined. Both points together form a local vector—the so-called axis of growth—that roughly indicates the orientation of the cytoplasm in this direction. [symbol] e nucleus line; a sorting of vectors with identical root points was performed by means of an analysis of the local position of the vectors relative to the nucleus line.

These local direction vectors were used to parametrize the respective [symbol] y means of cubic splines, the lengths of the flanking vectors were used besides their orientation. To allow for an adequate modeling of the concavities of the splines, the scalar product of respective adjacent direction vectors was employed as a local measure. To this end, first, all vectors were standardized and then the products were calculated. The range of values is between 1 and −1, with a product close to 1 representing very closely adjacent vectors and −1 representing the maximum possible span [symbol] [1 . . . 0]. Eventually, each pair of vectors is scaled with the pair thus formed. In this form, the pairs are then used directly for the parametrization of membrane line sections.

FIG. 5 illustrates an image of cancerous bone marrow tissue (U2OS [symbol] g. In FIG. 6, the cell nucleus line and axes of growth are marked in the same image. FIG. 7, in turn, shows the result of a membrane approximation with splines, the approximated membrane contour having been established using differently scaled direction vectors, as in the above de- [symbol] in this manner.

### Embodiment 4

In a preferred embodiment of the present method an analysis was applied to further cell types. Concretely, those also were cells in cancerous bone [symbol] s compared to the preceding Figures. In the cell tissue, the larger distances cause a higher degree of freedom of the formation of the cell contour of an individual cell. The above described landmarks were again used in the parametrization of splines by means of direction vectors (axes of growth). [symbol] o longer be sorted in the order of their positions on the membrane contour; the present example further demonstrates that for cells with a spacious extension of the cytoplasm, a position of the axes of growth that is more independent from the nucleus—that is, a local orientation—is advantageous and can be determined with the method forming the basis of the disclosure.

[symbol] thogonal to each other are determined. Thereafter, the set of landmarks was divided into two subsets A and B such that A included the marks situated in the first of the two half-planes formed by the shorter nucleus axis. Analogously, the set B included the marks of the second half-plane.

[symbol] d B:

A segment g was plotted, whose starting point was situated on the intersection s of the two nucleus axes. The direction of g was determined such that the distance of all landmarks in this half-plane became minimal with [symbol] is could well be used (R. Duda, P. Hart, D. Stork: Pattern Classification. Wiley-Interscience, 2001). The terminal point of g was determined to be the point p for which held: p is as close to s as possible, and no landmarks exist beyond the orthogonal to g through p.

[symbol] o sets so that these included the marks on either side of the calculated segment, respectively.

The procedure was repeated recursively, with the spaces on either side of g now being considered as the half-planes. Instead of the intersection s, [symbol] e discriminant. A new discriminant g′ was then calculated such that the remaining landmarks of the half-plane observed could be separated into disjoint sets.

The parallel processes described each ended as soon as a half-plane included only a single landmark. In this case, the terminal point of the dis- [symbol] discriminants formed in this manner now served as axes of growth and were considered as local orientations of the cell membrane line.

The graph constructed by the repeated calculation of discriminants now allowed for a simple sorting of the landmarks. To do so, a tree traversal [symbol] s determined first. Both graphs could be characterized more precisely as trees, and an order of the landmarks—located on the leaf nodes of the tree—could be established by a pre-order run performed on the tree (I. Bronstein, K. Semendjajew, G. Musiol, H. Mühlig: Taschenbuch der

[symbol]

In analogy with the previously indicated example of application, the membrane line was then constructed by a parametrization of spline segments, given by respective adjacent axes of growth. Also in analogy with the previous example, were scaled optionally with the scalar products [symbol] e neighboring cell type.

### Embodiment 5

The method underlying the disclosure was applied in another example, in order to detect the landmarks in the first place. To this end, the distribu- [symbol] d first. It is in the nature of many imaging techniques and test devices that the intensity is at a maximum around the nucleus and decreases in all directions towards the membrane line. This decrease is irregular insofar as the distance to the membrane line differs in all directions and, moreo-

[symbol]

Starting from the points on the nucleus line watersheds were looked for, i.e. those—not necessarily straight—lines that each indicate the ridge of the local intensity distribution (H. Meine, U. Köthe: Image Segmentation with the Exact Watershed Transform. In: Proceedings of the Fifth IASTED [symbol] ing, September 2005, p. 400-405).

The common methods of watershed transformation already account for a branching of the lines at branch points so that again a graph-like structure is obtained in this manner. In an intermediate step, cyclic edges were [symbol] e graphs. It was another objective to delete those edges that connected branch points of a graph belonging to a certain nucleus with the branch points of the graph of a neighboring nucleus. In this manner, the final terminal points of the graphs were formed as well. When watersheds of [symbol] m in this region. Comparably methods were applied to the delimitation from the background regions, the character of the image being decisive for the respective optimization of the graph performed.

From the leaves and the outermost nodes of the graphs, axes of growth [symbol] e section-wise parametrization of membrane line segments by means of spline approximation.

What is claimed is:

1. A method for detecting membrane contours in images of biological cells, said method comprising the following steps:
detecting a substructure of a biological cell, said substructure serving to localize the biological cell in the image,
detecting a plurality of landmarks with consideration to the spatial position of the substructure,
determining line segments between pairs of spatially adjacent landmarks, and
combining the line segments to a membrane contour,
wherein the physical-biological findings regarding the cell statics form the basis of the determination of the line segments.

2. The method of claim 1, wherein said substructure of the biological cell is a cell organelle, preferably the cell nucleus.

3. The method of claim 1, wherein said landmarks represent outer limit points of the cytoskeleton.

4. The method of claim 1, wherein, for the determination of the line segments, the cytoskeleton or components thereof are reconstructed, said reconstruction being carried out, in particular, using the knowledge about the position of substructures and/or landmarks, and wherein preferably the length, the orientation and/or the branching patterns of the cytoskeleton or the components thereof are determined.

5. The method of claim 1, wherein a model is used as the basis of the determination of the line segments, in which model the cell morphology, especially the membrane contour, is described as a function of the geometry of the cytoskeleton or the components thereof.

6. The method of claim 1, wherein, for the determination of the line segments, an energy-functional is minimized that depends on at least one parameter selected from the group consisting of: mechanical tension of the membrane, curvature of the membrane, border area energy, cell surface, cell volume, and osmotic pressure.

7. The method of claim 1, wherein polynomials or splines are used as line segments.

8. The method of claim 1, wherein the line segments are concave curves of the second or third order.

9. The method of claim 1, wherein the cell membrane defining the cell is determined as the contour.

10. The method of claim 1, wherein contours are determined in an image of biological tissue, in particular a tissue section or a confluent cell layer.

11. The method of claim 1, wherein contours are determined in an image of one or a plurality of cells in suspension.

12. The method of claim 1, wherein contours are determined in an image of one or more sedimented or adherent cells.

13. The method of claim 1, wherein information about the position and/or orientation of the substructure are accounted for in the detection of the landmarks and/or the determination of the line segments.

14. The method of claim 1, wherein information about the spatial density of the landmarks are taken into account in the determination of the line segments.

15. The method of claim 1, wherein a high spatial density of landmarks is accounted for such that flat line segments are obtained.

16. The method of claim 1, wherein findings of the tensegrity model are used to determine the line segments.

17. The method of claim 1, wherein (i) at least one axis is defined as the connection between a landmark and a point situated on the substructure, and (ii) the length and/or orientation of the axis is used in determining the line segments.

18. The method of claim 17, wherein at least two axes are defined and the angle between these two preferably adjacent axes is used in determining the line segments.

19. The method of claim 17, wherein splines are used in the determination of the line segments, the parameters of the splines being a function of the length and/or orientation of the axis or axes and/or the angle between two preferably adjacent axes.
